(19) United States
(12) Patent Application Publication
(10) Pub. No.: US 2009/0322877 A1
(43) Pub. Date: Dec. 31, 2009

(54) Cellular Control of Airborne Equipment

(76) Inventor: Benjamin Tigner, Laguna Beach, CA (US)

Correspondence Address: FISH & ASSOCIATES, PC;ROBERT D. FISH, 2603 Main Street, Suite 1000, Irvine, CA, 92614-6232, US

(21) Appl. No.: 12/107,243

(22) Filed: Apr. 22, 2008

Related U.S. Application Data
(63) Continuation-in-part of application No. 11/449,440, filed on Jun. 7, 2006.
(60) Provisional application No. 60/914,595, filed on Apr. 27, 2007.

(51) Int. Cl. H04N 7/18; H04W 4/00

(52) U.S. Cl. 348/144; 455/431; 348/E07.085

(57) ABSTRACT

A manned or unmanned aircraft, and equipment aboard the aircraft, are controlled through a cell phone network or other public package switched network. Some of the information downlinked from the aircraft may include video imagery acquired by sensors integrated with the aircraft. In addition, some of the information uplinked to the aircraft may include instructions to control equipment onboard the aircraft, including cameras, spotlights, and public-address systems.

This application is a continuation in part of U.S. Ser. No. 11/449,440, filed Jun. 7, 2006 and also claims priority to provisional application 60/914595, filed Apr. 27, 2007. The disclosure of that application, and all other extrinsic materials discussed herein, are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is aerial surveillance.

### BACKGROUND

Law enforcement agencies often find it useful to patrol target areas using aircraft. Most agencies employing patrol aircraft require such aircraft to be manned by at least two operators: a pilot in command (PIC) and a tactical flight officer (TFO). The PIC's responsibility includes operating the controls of the aircraft, using radios to interact with air traffic controllers, and avoiding collisions with ground obstacles and other aircraft. The TFO is responsible for conducting all ground surveillance and for relaying his observations to ground units who can respond appropriately. The TFO's tasks include making visual observation with the naked eye and with vision-enhancement equipment like gyro-stabilized cameras, infrared and night-vision equipment, spot-lights, binoculars, etc. The TFO also interacts with the PIC and communicates with dispatchers and other units on the ground through one or more voice radios.

In practical police air operation the TFO's workload can be overwhelming, sometimes compromising his ability to convey his observations to ground units. In addition, the TFO's ability to quickly convey his observations to ground units is handicapped by the limitations inherent in voice radio communication.

It is known to use RF video downlink systems to augment the TFO's voice communications. These systems provide ground-based display of video imagery acquired by cameras installed in the aircraft. Law enforcement use of video downlink equipment has grown in recent years due to concerns about homeland security, and due to the increasing public demand for oversight and accountability of law enforcement operators in the field.

Air Beat—The Official Journal of the Airborne Law Enforcement Association, March/April 2007 (Downlinking For Public Safety Collect, Integrate & Relay Information). Specific article references within the above citation having particular relevance are:
Solosky, Kenneth J. “Downlinking Big Apple Style”: 18-22;
Durso, Christopher M. “Next Generation Video Downlink Topology”: 24-26;
Roy, Jacqueline. “Digital Downlink—The Future of Airborne Video Surveillance”: 28-31; and
Murray, Robert. “Developing a Maintenance Checklist for Your Downlink Equipment”: 38-40.

Present-day video downlink systems suffer from several limitations, including very high equipment cost and a need for specialized equipment and training to operate ground elements. Included in the high cost is substantial infrastructure investment required to enable dissemination of the downlinked imagery to distributed command centers and emergency service personnel in the field.

One solution is to use the public data networks, such as the Internet, to disseminate imagery downlinked from aircraft. Current systems, however, utilize specialized receivers distributed at dedicated law-enforcement sites to receive RF signals from the aircraft, which are then fed in to the Internet.

### SUMMARY OF THE INVENTION

The present invention provides apparatus and methods in which a user communicates with a manned or unmanned aerial vehicle, and controls equipment on the vehicle, using a public package switched network.

The closest prior art, discussed in “Next Generation Video Downlink Topology”, discusses a multi-receiver system capable of injecting downlinked digital video data into the Internet for distribution, but based on information in the article, the system is neither A) a cellular system (i.e. capable of handoff from one cell site to another) or B) based on pre-existing commercial infrastructure, or C) able to uplink control data from ground controllers back to the aircraft.

### BRIEF DESCRIPTION OF THE DRAWING

FIG. 1 is a schematic of a user communicating with a manned or unmanned aerial vehicle, and controls equipment on the vehicle, using a public package switched network.

### DETAILED DESCRIPTION

The present invention uses commercial cellular phone and cellular wide-band data networks to exchange bi-directional digital data with aircraft, and provides for Internet distribution of this data. Some of the information downlinked from the aircraft may include video imagery acquired by sensors integrated with the aircraft. In addition, some of the information uplinked to the aircraft may include instructions to control equipment onboard the aircraft, including cameras, spotlights, and public-address systems. Though present-day commercial cellular networks are inadequate for downlinking uncompressed high-quality video in real time, commercial cellular technology and deployed infrastructures are still evolving rapidly, and within a few years it is likely that most metropolitan areas will have sufficient deployed commercial infrastructure to allow good-quality real-time video distribution, at least when incorporated with advanced data compression technology.

The invention substantially reduces the user cost of video downlink capability by employing pre-existing commercial infrastructure rather than. Commercial cellular networks are already integrated with the Internet, enabling real-time distribution of imagery to multiple distributed ground displays with no additional infrastructure. Furthermore, the invention allows video to be displayed on general purpose computer screens including those already incorporated in most modern emergency service vehicles, instead of specialized downlink-receiver screens. The invention also facilitates distribution of imagery and other data to mobile wireless computing devices like PDAs and cell-phones.

The invention offers utility beyond the scope of existing downlink systems by providing ground operators the ability to augment or replace the TFO through remote control of onboard sensors and other equipment. The control signals for such remote operation can originate from Internet-connected computers at fixed-based command centers, or from mobile wireless computing devices.

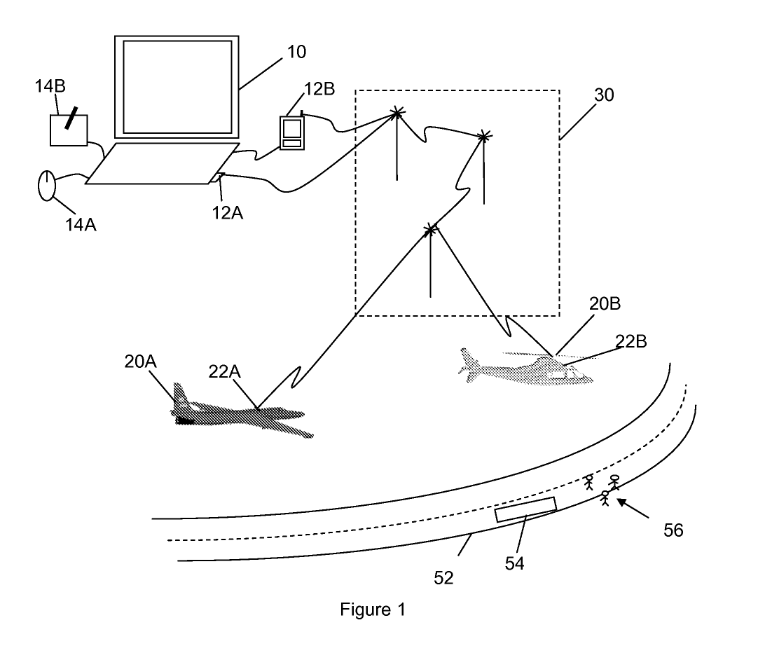

In FIG. 1, for example, a system 1 includes a computer 10 having a network interface card 12A and/or a cell phone 12B, and a manned or unmanned aerial vehicle (AV) 20A or 20B equipped with a network interface 22A or 22B (individually or collectively referred to herein as 22x) and on-board electronic equipment such as cameras 24A, 24B. One or both of the interface card 12A and/or a cell phone 12B can have encryption. Signals between the network interfaces 12, 22 are carried by a cell phone or other public package switched network 30. A single user could readily control both an aircraft 20A, 20B and its on-board electronic equipment 24A, 24B, through the network interfaces 22A or 22B, respectively. Used in this manner the AV 20x can be used to monitor a roadway 52.

It is contemplated that a single user could also control multiple AVs simultaneously, such as aircraft 20A, 20B, without additional expensive ground equipment, and indeed could visualize data feeds from multiple AVs simultaneously on the same computer display. It is also contemplated that a first ground controller could hand off control of a AV to a second ground controller. It is additionally contemplated that data feeds from any single AV could be visualized by multiple users simultaneously, with no requirement for additional equipment.

The computer has a mouse 14A and/or joystick 14B interfaces that can be used to provide commands to the AV 20. Such example are meant to euphemistically represent all suitable interfaces, including for example keyboards and scratch pads. The computer also includes a flat or other display screen 16 that can be used to visualize geo-positioning of the AV 20x and/or visual or other data being sent by the AV 20. The computer is preferably used by a policeman or law enforcement personnel, but could be used by anyone. Such use could take place in or at a motor vehicle, but could just as easily take place in a home, office, or any other environment.

The network 30, represented pictorially here by cell towers, can be any size, and of any nature. In preferred embodiments the network 30 is a cell phone network. The network 30 may also include part of the Internet.

The AV 20x can be any suitable aircraft, including for example both fixed and rotating wing aircraft. The AV 20x can carry assistance equipment (not shown), or any type of ordnance, including for example tire-puncture stars that could be dropped in front of a fleeing vehicle.

Any object or territory can be placed under surveillance, including for example roadway 52, fleeing vehicle 54, and/or one or more persons 56 who may be in the act of committing a crime (shown here as selling drugs to a person (not shown) inside vehicle 54.

The AV 20x can be programmed to execute any and all suitable instructions, including instructions to perform a set of tasks upon occurrence of a given situation. For example, upon loss of communication with the computer, the AV 20x can be programmed to return to point of take-off or other location, self destruct, take evasive action, or fly in a widening circle to search for a network connection.

There are several sensors and servo control systems that could be utilized, including for example, the μNAV™ by Crossbow Technology, Inc. See http://www.xbow.com/General_info/Info_pdf_files/uNAV_PR.pdf.

Contemplated business operations include marketing a system as described herein, or portions thereof, to a law enforcement agency. An especially contemplated embodiment comprises leasing or renting the equipment based upon an operating cost schedule. Thus, one might bill a police department at a rate of $65/flight hour for a given number of AVs and/or a given number of software packages or computers. That way the department would have little or no out of pocket expenses for purchasing or maintaining the equipment per se, and would only have to pay what amounts to usage fees.

Thus, specific embodiments and applications of cellular control of airborne equipment have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A method of communicating between an airborne aircraft and non-airborne equipment, comprising:
target surveillance information being acquired by a sensor installed in the aircraft, and at least some of this information being transmitted through a cellular data network to ground-based displays, and
a user operating control equipment to generate control signals that are transmitted to an aircraft through a cellular data network and used to operate equipment onboard the aircraft.

2. The method of claim 1, further comprising operating the aircraft by or on behalf of at least one of a civilian law enforcement organization and a media organization.

3. The method of claim 1, wherein the target is at least one of a criminal suspect and a public gathering.

4. The method of claim 1, wherein the equipment onboard the aircraft comprises a camera, and the signals control at least one of an imaging function, a pointing function, and a duration of image acquisition.

5. The method of claim 1, wherein the equipment onboard the aircraft comprises a speaker.

6. The method of claim 1, wherein the equipment onboard the aircraft comprises a drop-release mechanism.

7. The method of claim 1, wherein the at least some of the signals control a data compression characteristic of data transmitted from the aircraft

8. The method of claim 1, wherein at least some of the signals control an extent of data recording and later re-transmission of video imagery.

9. The method of claim 1, wherein the user is a non-military personnel.

10. A surveillance system, comprising:
an unmanned aircraft operable through signals received directly from a transmitter of a public package switched network, and
electronic equipment disposed onboard the aircraft that is also operable through the public package switched network while the aircraft is in flight.

11. The system of claim 10, further comprising a security subsystem that encodes the signals.

12. The system of claim 1, further comprising display software operable upon a computer that facilitates control of the aircraft through a joystick.

13. The system of claim 10, wherein the signals are carried to the transmitter by a second transmitter.

14. The system of claim 10, wherein the equipment onboard the aircraft comprises a camera, and the signals control at least one of an imaging function, a pointing function, and a duration of image acquisition.

15. The system of claim 10, wherein the equipment onboard the aircraft comprises a speaker.

16. The system of claim 10, wherein the equipment onboard the aircraft comprises a drop-release mechanism.
